(19) United States
(12) Patent Application Publication
(10) Pub. No.: US 2025/0095671 A1
(43) Pub. Date: Mar. 20, 2025

(54) INFORMATION PRESENTATION APPARATUS, INFORMATION PRESENTATION METHOD, AND INFORMATION PRESENTATION PROGRAM

(71) Applicant: NIPPON TELEGRAPH AND TELEPHONE CORPORATION, Tokyo (JP)

(72) Inventors: Mitsuhiro GOTO, Tokyo (JP); Soichiro UCHIDA, Tokyo (JP)

(73) Assignee: NIPPON TELEGRAPH AND TELEPHONE CORPORATION, Tokyo (JP)

(21) Appl. No.: 18/726,828

(22) PCT Filed: Jan. 26, 2022
(86) PCT No.: PCT/JP2022/002841

§ 371 Date: Jul. 5, 2024

(51) Int. Cl. G10L 25/60; G10L 15/22

(52) U.S. Cl. CPC G10L 25/60; G10L 15/22

(57) ABSTRACT

The information presentation device according to an embodiment includes: an acquisition unit configured to acquire a speech speed and a sound pressure of an utterance at a predetermined interval; a determination unit configured to determine whether at least one of the speech speed or the sound pressure needs to be improved or not; and a presentation content control unit configured to acquire a pseudo heartbeat sound in a case where it is determined that the speech speed needs to be improved, acquire a bubble noise in a case where it is determined that the sound pressure needs to be improved, and output presentation information including at least one of the pseudo heartbeat sound or the bubble noise.

### TECHNICAL FIELD

The present invention relates to an information presentation device, an information presentation method, and an information presentation program.

### BACKGROUND ART

In recent years, due to the influence of COVID-19 and the like, online voice communication such as a Web meeting is becoming mainstream.

For example, in a face-to-face meeting, a user who is a speaker can receive feedback as to whether his/her utterance is correctly conveyed to a listener or not while grasping the expression and condition of the listener. Then, the user utters while controlling paralinguistic elements (e.g., speech speed, sound pressure (volume), etc.) at the time of utterance on the basis of the feedback. However, in online voice communication, since the user has few opportunities to obtain feedback on the utterance, it tends to be difficult to determine whether the user is making an utterance that is easy to be conveyed to the listener or not as compared with the face-to-face format.

Non Patent Literature 1 proposes improving the speech speed by quantitatively evaluating the speech speed before the meeting and notifying the speaker of whether the speech speed is appropriate or not.

Non Patent Literature 2 proposes improving the sound pressure by measuring the sound pressure and displaying feedback on a screen according to the sound pressure.

### CITATION LIST

### Non Patent Literature

Non Patent Literature 1: Wataru Sugiyama, Ryota Nakamura, and Noriyuki Kamibayashi, “Self-check Service to Evaluate and Improve Quantitatively Admeasurement of Appropriate Rate by Introducing Speech Recognition Technology”, IPSJ Proceedings of the 76th Annual Convention, 2ZF-2, 2014
Non Patent Literature 2: Xinbo Zhao, Takaya Yuizono, and Jun Munemori, “Comparison between Voice Feedback and Visual Feedback by Using Presentation Practice Support System PRESENCE”, IPSJ SIG Technical Report, Vol. 2017-GN-101, No. 14, 2017

### SUMMARY OF INVENTION

### Technical Problem

Non Patent Literature 1 has a problem that improvement of the speech speed is restrictive even if feedback of the speech speed of the user is fed back and it is presented that the speech speed is inappropriate. Moreover, Non Patent Literature 2 has a problem that the effect of increasing the sound pressure is restrictive even if the shortage of the utterance volume (sound pressure) is visually and audibly fed back in real time at the time of presentation.

Moreover, when the user is in a tension state, speech speed may become faster or utterance at an appropriate volume may not be made. In such a case, even if the user himself/herself is conscious of controlling paralinguistic elements, there is a problem that the user makes an utterance that is difficult to be conveyed to the listener.

The present invention has been made in view of the above circumstances, and an object thereof is to provide a technology for involuntarily and non-perceptually controlling paralinguistic elements of a user in an online meeting or the like, and making it possible for the user to make an utterance that is easy to be conveyed to the listener.

### Solution to Problem

In order to solve the above problems, an aspect of the present invention is an information presentation device including: an acquisition unit configured to acquire a speech speed and a sound pressure of an utterance at a predetermined interval; a determination unit configured to determine whether at least one of the speech speed or the sound pressure needs to be improved or not; and a presentation content control unit configured to acquire a pseudo heartbeat sound in a case where it is determined that the speech speed needs to be improved, acquire a bubble noise in a case where it is determined that the sound pressure needs to be improved, and output presentation information including at least one of the pseudo heartbeat sound or the bubble noise.

### Advantageous Effects of Invention

According to an aspect of the present invention, paralinguistic elements of the user are involuntarily and non-perceptually controlled, and the user can make an utterance that is easy to be conveyed to the listener in an online meeting or the like.

### BRIEF DESCRIPTION OF DRAWINGS

FIG. 1 is a block diagram illustrating an example of a hardware configuration of an information presentation device according to an embodiment.

FIG. 2 is a block diagram illustrating a software configuration of the information presentation device according to the embodiment in association with the hardware configuration illustrated in FIG. 1.

FIG. 3 is a flowchart illustrating an example of an information presentation operation of the information presentation device.

FIG. 4 is a flowchart illustrating an example in which the operation of step ST101 is described in more detail.

FIG. 5 is a diagram illustrating an example of a speech speed and a sound pressure stored in a state storage unit.

FIG. 6 is a flowchart illustrating an example in which the operation of step ST102 is described in more detail.

FIG. 7 is a diagram illustrating an example of a speech speed threshold and a sound pressure threshold stored in a threshold storage unit.

FIG. 8 is a diagram illustrating an example of presentation information stored in a presentation content storage unit.

FIG. 9 is a flowchart illustrating an example in which the operation of step ST104 is described in more detail.

FIG. 10 is a block diagram illustrating a software configuration of an information presentation device according to a first variation of the embodiment in association with the hardware configuration illustrated in FIG. 1.

FIG. 11 is a diagram illustrating an example of presentation information stored in a presentation content storage unit.

FIG. 12 is a flowchart illustrating an example of an information presentation operation of the information presentation device.

FIG. 13 is a flowchart illustrating an example in which the operation of step ST104 is described in more detail.

### DESCRIPTION OF EMBODIMENTS

Hereinafter, an embodiment according to the present invention will be described with reference to the drawings. Note that, hereinafter, the same or similar reference signs will be given to components that are the same as or similar to those already described, and redundant description will be basically omitted.

### Embodiment

### (Configuration)

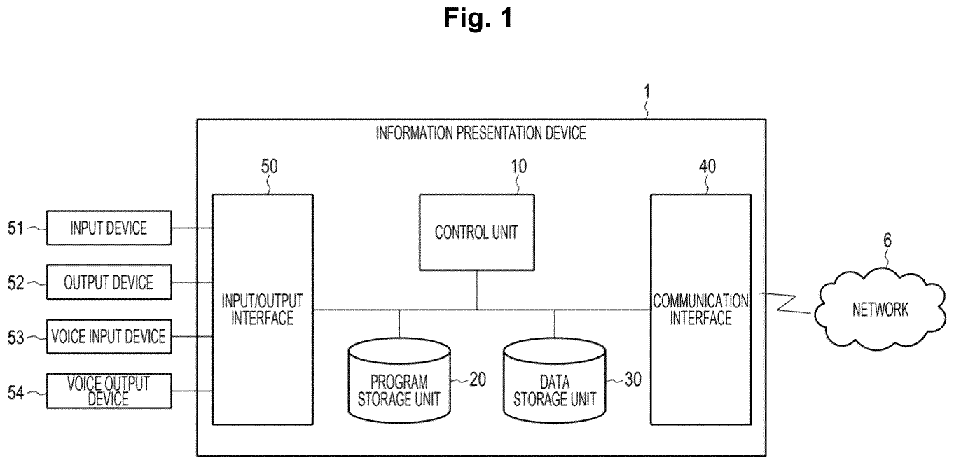

FIG. 1 is a block diagram illustrating an example of a hardware configuration of an information presentation device 1 according to an embodiment.

The information presentation device 1 may be, for example, a user terminal used by a user participating in an online meeting. Here, the user terminal may be any computer that can be generally used by a user, such as a personal computer (PC), a smartphone, a tablet terminal, or a wearable terminal. Moreover, the information presentation device 1 may be a server with which the user terminal is connected via a network. Moreover, the server may be any computer as long as the computer can be used as a server.

The information presentation device 1 includes a control unit 10, a program storage unit 20, a data storage unit 30, a communication interface 40, and an input/output interface 50. The control unit 10, the program storage unit 20, the data storage unit 30, the communication interface 40, and the input/output interface 50 are communicably connected with each other via a bus.

The information presentation device 1 is implemented by a computer such as a personal computer (PC). The information presentation device 1 includes a control unit 10, a program storage unit 20, a data storage unit 30, a communication interface 40, and an input/output interface 50. The control unit 10, the program storage unit 20, the data storage unit 30, the communication interface 40, and the input/output interface 50 are communicably connected with each other via a bus. Moreover, the information presentation device 1 is connected with a device used by another user or a server via a network 6.

The control unit 10 controls the information presentation device 1. The control unit 10 includes a hardware processor such as a central processing unit (CPU).

For example, the program storage unit 20 is configured by combining a non-volatile memory capable of writing and reading as needed, such as a solid state drive (SSD), and a non-volatile memory such as a read only memory (ROM) as storage media, and stores an application program necessary for executing various types of control processing according to an embodiment, in addition to middleware such as an operating system (OS). Note that the OS and each application program will be hereinafter collectively referred to as a program.

The data storage unit 30 may be, for example, a combination of a non-volatile memory capable of writing and reading as needed, such as an SSD, and a volatile memory such as a random access memory (RAM) as storage media.

The communication interface 40 includes one or more wired or wireless communication modules. For example, the communication interface 40 includes a communication module that establishes wired or wireless connection with a device used by another user or a server via the network 6. For example, the communication interface 40 may include a wireless communication module capable of establishing wireless connection with a Wi-Fi access point or the like. That is, the communication interface 40 may be a general communication interface as long as it can communicate with a device used by another user, a server, or the like under the control of the control unit 10 to transmit and receive various types of information.

The input/output interface 50 is connected with an input device 51, an output device 52, a voice input device 53, a voice output device 54, and the like. The input/output interface 50 is an interface that enables transmission and reception of information to and from the input device 51, the output device 52, the voice input device 53, and the voice output device 54. The input/output interface 50 may include a wired or wireless communication interface. For example, the information presentation device 1 and at least one of the input device 51, the output device 52, the voice input device 53, or the voice output device 54 are wirelessly connected using a short-range wireless technology or the like, and may transmit and receive information using the short-range wireless technology.

The input device 51 includes, for example, a keyboard, a pointing device, or the like for an owner (e.g., a user or the like) of the information presentation device 1 to input an instruction to the information presentation device 1. Moreover, the input device 51 may include a reader for reading data to be stored in the data storage unit 30 from a memory medium such as a USB memory, and a disk device for reading such data from a disk medium.

The output device 52 includes a display that displays output data to be presented from the information presentation device 1 to the owner, a printer that prints the output data, and the like.

The voice input device 53 may be, for example, a microphone. That is, the voice input device 53 is disposed near the user (speaker), collects the utterance of the user, and converts the utterance into an electrical signal.

The voice output device 54 may be an ear device, a speaker, or the like. The voice output device 54 is used to output voice information uttered by another user or voice information stored in the data storage unit 30 as a voice. Here, the voice output device 54 may be a sound conduction type ear device such as an earphone or a headphone, or may be a bone conduction type ear device.

Furthermore, the voice input device 53 and the voice output device 54 may be a device in which the voice input device 53 and the voice output device 54 are integrated, such as a headset or a speaker phone.

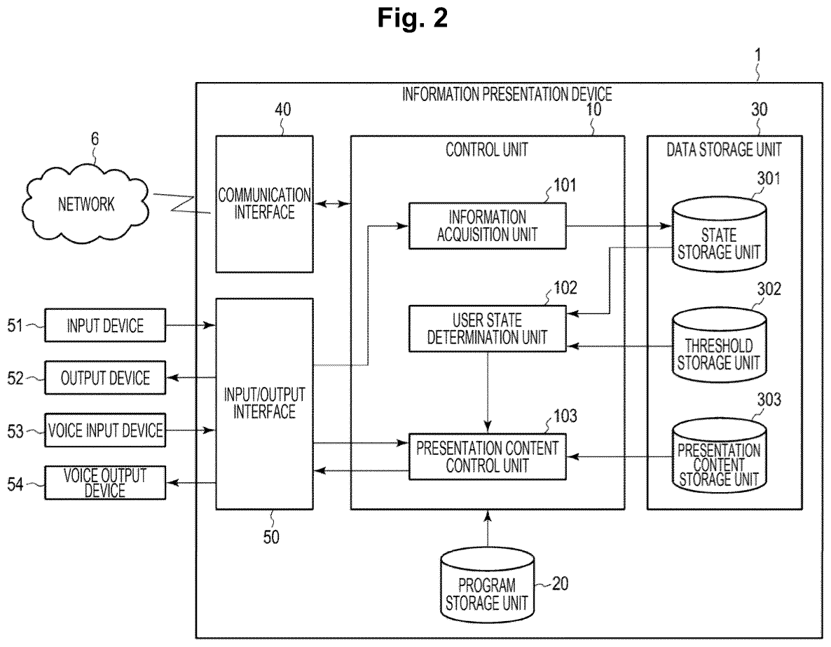

FIG. 2 is a block diagram illustrating a software configuration of the information presentation device 1 according to the embodiment in association with the hardware configuration illustrated in FIG. 1.

The data storage unit 30 includes a state storage unit 301, a threshold storage unit 302, and a presentation content storage unit 303.

The state storage unit 301 is used to store voice information or the like corresponding to a voice uttered by a speaker acquired by an information acquisition unit 101 of the control unit 10 to be described later.

The threshold storage unit 302 is used to store a threshold to be used by a user state determination unit 102 of the control unit 10 to be described later for determining whether the utterance of the user needs to be improved or not.

The presentation content storage unit 303 stores a pseudo heartbeat sound and a bubble noise to be used by a presentation content control unit 103 of the control unit 10 to be described later for improving the utterance of the user.

The control unit 10 includes the information acquisition unit 101, the user state determination unit 102, and the presentation content control unit 103.

The information acquisition unit 101 receives voice information from the voice input device 53, and stores the received voice information in the state storage unit 301 at a predetermined interval. Moreover, the information acquisition unit 101 can calculate the speech speed on the basis of the voice information stored in the state storage unit 301 and measure the sound pressure. That is, the information acquisition unit 101 can acquire the speech speed and the sound pressure of the utterance at a predetermined interval. Furthermore, the information acquisition unit 101 stores the calculated speech speed and the measured sound pressure in the state storage unit 301.

The user state determination unit 102 acquires the speech speed and the sound pressure stored in the state storage unit 301. Then, the user state determination unit 102 calculates an average speech speed and an average sound pressure. Furthermore, the user state determination unit 102 acquires a speech speed threshold and a sound pressure threshold stored in the threshold storage unit 302. Then, the user state determination unit 102 compares the average speech speed with the speech speed threshold, compares the average sound pressure with the sound pressure threshold, and determines whether at least one of the speech speed or the sound pressure needs to be improved or not.

In a case where it is determined that at least one of the speech speed or the sound pressure needs to be improved, the presentation content control unit 103 outputs presentation information for improving the utterance of the user. For example, in a case where it is determined that it is necessary to improve the speech speed, the presentation content control unit 103 acquires a pseudo heartbeat sound stored in the presentation content storage unit 303 and outputs the presentation information including the pseudo heartbeat sound to the voice output device 54. Alternatively, in a case where it is determined that it is necessary to improve the sound pressure, the presentation content control unit 103 acquires a bubble noise and outputs presentation information including the bubble noise to the voice output device 54.

Here, it is known that, when a pseudo heartbeat sound having a heart rate different from the heartbeat sound of the user is presented to the user, the heartbeat sound of the user gets closer to the pseudo heartbeat sound (see, e.g., Nakamura et al., A System for Controlling Biological Condition using Feedback of False Information, IPSJ Interaction 2012 (2021), etc.). Therefore, the presentation content control unit 103 presents the pseudo heartbeat sound to the user as the presentation information in order to alleviate the tension state of the user and improve the speech speed. Moreover, it is known that what is most effective in presenting feedback information to the user is the auditory sense (see, e.g., Miyata et al., “Biofeedback Ryoho (in Japanese) (Biofeedback Therapy)”, New physiological psychology 2 (1997), etc.). Therefore, the presentation content control unit 103 may output the presentation information to the voice output device 54.

Furthermore, it is known that, in a noise environment, a sound pressure and a fundamental frequency of a voice increase in order to make it easier to transmit one's own voice to the other person as compared with a silent environment (see, e.g., Lane, H. L, The Lombard Sign and the Role of Hearing in Speech, etc.). Therefore, in order to improve the sound pressure of the utterance of the user, the presentation content control unit 103 presents a bubble noise to the user as presentation information.

### (Operation)

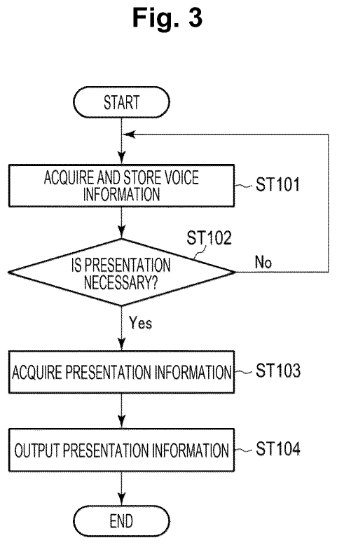

FIG. 3 is a flowchart illustrating an example of an information presentation operation of the information presentation device 1.

The control unit 10 of the information presentation device 1 reads and executes a program stored in the program storage unit 20, thereby implementing the operation of this flowchart.

The operation starts when the user (speaker) of the information presentation device 1 participates in, for example, an online meeting or the like in which the user needs to speak online. Note that, although an online meeting will be assumed in the following description for simplification, it is a matter of course that the present invention is not limited to an online meeting or the like. For example, a face-to-face meeting or the like may be used as long as the utterance of the user can be recorded, analyzed, and fed back to the user.

The information acquisition unit 101 of the control unit 10 acquires voice information and stores the acquired voice information in the state storage unit 301 (step ST101). The voice input device 53 converts a voice uttered by the user into voice information, and outputs the voice information obtained by conversion to the information acquisition unit 101. Then, the information acquisition unit 101 stores the speech speed and the sound pressure acquired from the voice information in the state storage unit 301.

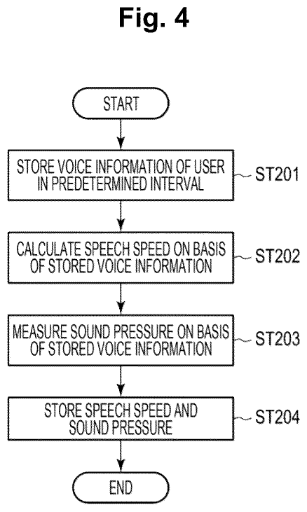

FIG. 4 is a flowchart illustrating an example in which the operation of step ST101 is described in more detail.

The information acquisition unit 101 stores voice information divided at a predetermined interval in the state storage unit 301 (step ST201). The information acquisition unit 101 divides the voice information received from the voice input device 53 at a predetermined interval T, allocates a recording ID to each piece of the divided voice information, and stores the divided voice information in the state storage unit 301. Here, the predetermined interval T may be any interval, and may be, for example, 1 minute (60,000 ms).

The information acquisition unit 101 calculates the speech speed on the basis of the voice information stored in the state storage unit 301 (step ST202). The information acquisition unit 101 acquires voice information in the predetermined interval T stored in the state storage unit 301. Then, the information acquisition unit 101 calculates the number of characters N_{word} included in the acquired voice information. That is, the calculated number of characters N_{word} is the number of characters included in the predetermined interval T. Then, the information acquisition unit 101 calculates the speech speed S (words/min) from N_{word}/T.

The information acquisition unit 101 measures the sound pressure on the basis of the voice information stored in the state storage unit 301 (step ST203). The information acquisition unit 101 measures the sound pressure P (dB) from the voice information in the predetermined interval T acquired in step ST202. Here, the sound pressure P may be an average sound pressure in the interval T. Note that the sound pressure P may be measured by a general method, and thus a detailed description thereof will be omitted here.

The information acquisition unit 101 store the calculated speech speed S and the measured sound pressure P in the state storage unit 301 (step ST204). For example, the information acquisition unit 101 stores the speech speed and the sound pressure in the state storage unit 301 in association with the recording ID. As described above, the information acquisition unit 101 acquires the speech speed and the sound pressure of the utterance in the predetermined interval.

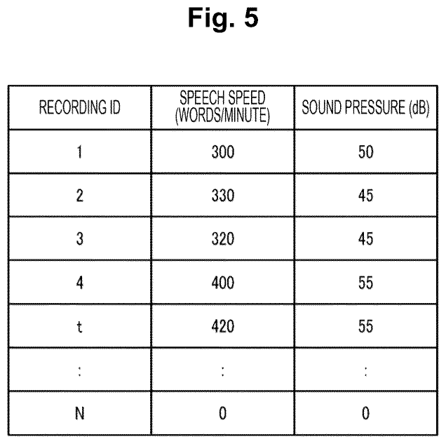

FIG. 5 is a diagram illustrating an example of a speech speed and a sound pressure stored in the state storage unit 301.

As illustrated in FIG. 5, a recording ID is assigned to each piece of voice information for each interval T, and a table in which the speech speed S (words/minute) and the sound pressure (dB) for each recording ID are recorded is stored in the state storage unit 301. For example, in a period in which the recording ID is 1, it is indicated that the user is uttering at a speech speed S of 300 (words/minute) and a sound pressure of 50 (dB). Moreover, for example, the speech speed S and the sound pressure P acquired from new voice information may be stored in a new row in a lower part of the table in FIG. 5.

With reference to FIG. 3, the user state determination unit 102 of the control unit 10 determines whether it is necessary to present improvement information to the user or not (step ST102). The user state determination unit 102 determines whether to present the presentation information for improving the utterance of the user or not on the basis of the speech speed S and the sound pressure P stored in the state storage unit 301.

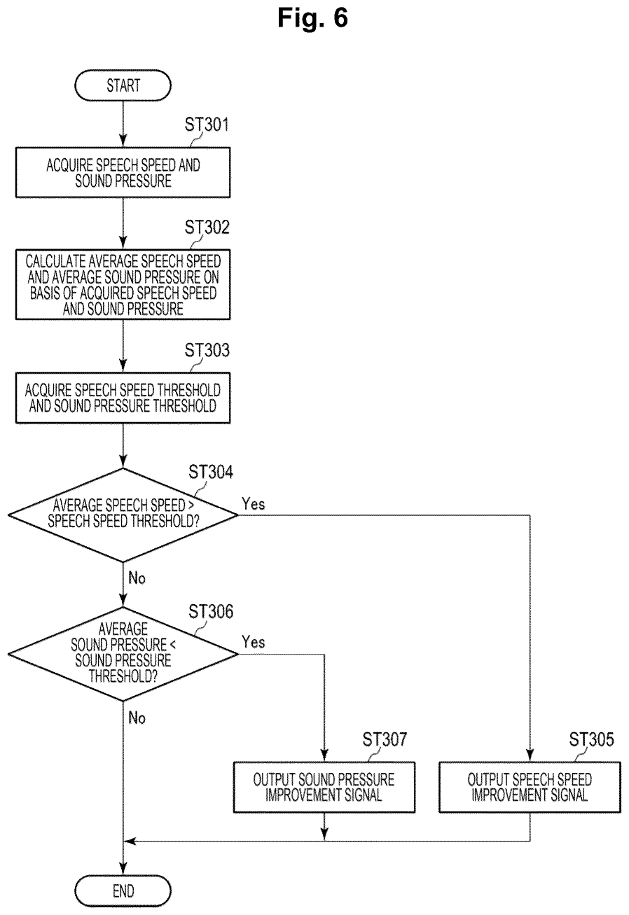

FIG. 6 is a flowchart illustrating an example in which the operation of step ST102 is described in more detail.

The user state determination unit 102 acquires the speech speed S and the sound pressure P stored in the state storage unit 301 (step ST301). For example, the user state determination unit 102 may acquire the speech speed S and the sound pressure P for M rows stored in the state storage unit 301. Here, M may be any plural number defined in advance.

The user state determination unit 102 calculates an average speech speed Sₐᵥₑ and an average sound pressure Pₐᵥₑ on the basis of the acquired speech speed S and sound pressure P (step ST302). The user state determination unit 102 calculates an average speech speed Sₐᵥₑ from the acquired M speech speeds Si. Here, i is any integer from 1 to M, and indicates the i-th speech speed among the acquired M speech speeds. For example, the user state determination unit 102 acquires the average speech speed Sₐᵥₑ on the basis of the following expression.

$${S}_{ave} = \sum {S}_{i} / M ( i = 1 , … , M )$$

Similarly, the user state determination unit 102 calculates an average sound pressure Pₐᵥₑ from the acquired M sound pressures Pᵢ. For example, the user state determination unit 102 acquires the average sound pressure Pₐᵥₑ on the basis of the following expression.

$${P}_{ave} = 10 {log}_{10} ( \sum {10}^{Pi / 10} ) - 10 {log}_{10} N ( i = 1 , … , M )$$

The user state determination unit 102 acquires the speech speed threshold Sₜₕ and the sound pressure threshold Pₜₕ stored in the threshold storage unit 302 (step ST303).

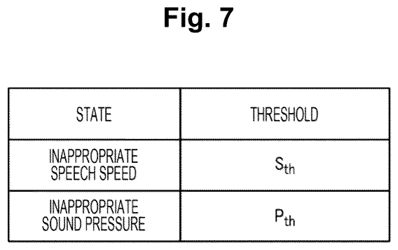

FIG. 7 is a diagram illustrating an example of the speech speed threshold Sₜₕ and the sound pressure threshold Pₜₕ stored in the threshold storage unit 302.

As illustrated in FIG. 7, the threshold storage unit 302 stores a speech speed threshold Sₜₕ indicating that the speech speed is inappropriate and a sound pressure threshold Pₜₕ indicating that the sound pressure is inappropriate. Note that, although FIG. 7 illustrates only one speech speed threshold and one sound pressure threshold for simplification, it is a matter of course that the threshold storage unit 302 may store a plurality of speech speed thresholds and a plurality of sound pressure thresholds. The user state determination unit 102 acquires the speech speed threshold and the sound pressure threshold from the threshold storage unit 302.

The user state determination unit 102 determines whether the average speech speed Sₐᵥₑ is larger than the speech speed threshold Sₜₕ or not (step ST304). The user state determination unit 102 compares the average speech speed Sₐᵥₑ with the speech speed threshold Sₜₕ, and determines whether the average speech speed Sₐᵥₑ is larger than the speech speed threshold Sₜₕ or not. In a case where it is determined that the average speech speed Sₐᵥₑ is larger than the speech speed threshold Sₜₕ, the processing proceeds to step ST305. In a case where it is determined that the average speech speed Sₐᵥₑ is equal to or smaller than the speech speed threshold Sₜₕ, the processing proceeds to step ST306.

The user state determination unit 102 outputs a speech speed improvement signal to the presentation content control unit 103 (step ST305). In a case where it is determined in step ST304 that the average speech speed Sₐᵥₑ is larger than the speech speed threshold Sₜₕ, this means that the user is speaking faster than a speed that can be understood by the listener. Thus, the user state determination unit 102 outputs a speech speed improvement signal indicating that the speech speed of the user needs to be improved to the presentation content control unit 103.

The user state determination unit 102 determines whether the average sound pressure Pₐᵥₑ is smaller than the sound pressure threshold Pₜₕ or not (step ST306). The user state determination unit 102 compares the average sound pressure Pₐᵥₑ with the sound pressure threshold Pₜₕ, and determines whether the average sound pressure Pₐᵥₑ is smaller than the sound pressure threshold Pₜₕ or not. In a case where it is determined that the average sound pressure Pₐᵥₑ is smaller than the sound pressure threshold Pₜₕ, the processing proceeds to step ST307. In a case where it is determined that the average sound pressure Pₐᵥₑ is equal to or larger than the sound pressure threshold Pₜₕ, the processing ends.

The user state determination unit 102 outputs a sound pressure improvement signal to the presentation content control unit 103 (step ST307). In a case where it is determined in step ST306 that the average sound pressure Pₐᵥₑ is smaller than the sound pressure threshold Pₜₕ, this means that the user is speaking with a volume that is difficult for the listener to hear. Thus, the user state determination unit 102 outputs a sound pressure improvement signal indicating that the sound pressure of the user needs to be improved to the presentation content control unit 103.

Here, a case where the processing of step ST305 or step ST307 is performed corresponds to a case where it is determined in step ST102 illustrated in FIG. 3 that presentation is necessary. On the other hand, a case where it is determined in step ST306 that the average sound pressure Pₐᵥₑ is larger than the sound pressure threshold Pₜₕ corresponds to a case where it is determined in step ST102 illustrated in FIG. 3 that presentation is unnecessary.

Note that, although whether the average speech speed Sₐᵥₑ is larger than the speech speed threshold Sₜₕ or not is determined first in the example in FIG. 6 in order to prioritize the improvement of the speech speed, the improvement of the sound pressure may be prioritized. For example, in a case where the utterance of the user content cannot be heard because the sound pressure of the utterance is too low, the control unit 10 may perform control so as to prioritize improvement of the sound pressure. In this case, the control can be implemented by interchanging step ST304 and step ST306.

Moreover, the user state determination unit 102 may determine that it is necessary to improve both the speech speed and the sound pressure. In this case, the processing may be changed such that step ST306 is implemented after it is determined in step ST304 that the speech speed needs to be improved. Then, in a case where it is determined that both the speech speed and the sound pressure need to be improved, the user state determination unit 102 may output an improvement signal indicating that both the speech speed and the sound pressure need to be improved to the presentation content control unit 103.

Furthermore, the threshold storage unit 302 may store a speech speed lower limit threshold S_{th_min}. Then, in step ST303, the user state determination unit 102 may also acquire the speech speed lower limit threshold S_{th_min}. Then, in step ST304, the user state determination unit 102 may determine whether the average speech speed Sₐᵥₑ is smaller than the speech speed lower limit threshold S_{th_min} or not. Then, in a case where it is determined that the average speech speed Sₐᵥₑ is smaller than the speech speed lower limit threshold S_{th_min}, the user state determination unit 102 may output a speech speed improvement signal to the presentation content control unit 103 in step ST305. For example, it is conceivable that the speech speed of the user is slow and the listener is bored or irritated. Thus, the user state determination unit 102 may output a speech speed improvement signal to the presentation content control unit 103.

With reference to FIG. 3, the presentation content control unit 103 of the control unit 10 acquires the presentation information (step ST103). The presentation content control unit 103 acquires the presentation information stored in the presentation content storage unit 303 according to the content of the signal received from the user state determination unit 102.

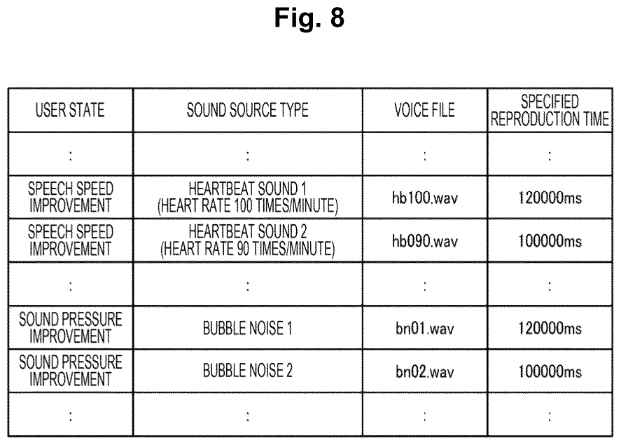

FIG. 8 is a diagram illustrating an example of the presentation information stored in the presentation content storage unit 303.

As illustrated in FIG. 8, the presentation content storage unit 303 stores a user state, a sound source type, a voice file, a specified reproduction time, and the like. The user state indicates, for example, a state that the user should improve, and indicates, for example, whether the user should improve the speech speed (speech speed improvement) or not, or improve the sound pressure (sound pressure improvement) or not. As the sound source type, a pseudo heartbeat sound is stored in the case of speech speed improvement, and a bubble noise is stored in the case of sound pressure improvement. Moreover, although FIG. 8 illustrates an example in which the specified reproduction time is different for each file, the specified reproduction time may be the same.

For example, in a case where the speech speed improvement signal is received from the user state determination unit 102, the presentation content control unit 103 may randomly select one from files in which the user state is speech speed improvement. For example, in a case where the speech speed improvement signal is received, the presentation content storage unit 303 randomly selects either a pseudo heartbeat sound that is heartbeat sound 1 or a pseudo heartbeat sound that is heartbeat sound 2. Moreover, for example, only one file corresponding to speech speed improvement may be stored in the presentation content storage unit 303. For example, in a case where the speech speed improvement signal is received, the presentation content control unit 103 will select the file.

Similarly, for example, in a case where the sound pressure improvement signal is received from the user state determination unit 102, the presentation content control unit 103 may randomly select one from files (pseudo heartbeat sounds) in which the user state is sound pressure improvement. For example, in a case where the sound pressure improvement signal is received, the presentation content storage unit 303 randomly selects either the bubble noise 1 or the bubble noise 2. Moreover, in a case where an improvement signal indicating that both the speech speed and the sound pressure need to be improved is received, the presentation content control unit 103 may acquire files of both the pseudo heartbeat sound and the bubble noise. Here, for example, only one file corresponding to the sound pressure improvement may be stored in the presentation content storage unit 303. For example, in a case where the sound pressure improvement signal is received, the presentation content control unit 103 will select the file.

The presentation content control unit 103 outputs the acquired presentation information via the input/output interface 50 (step ST104).

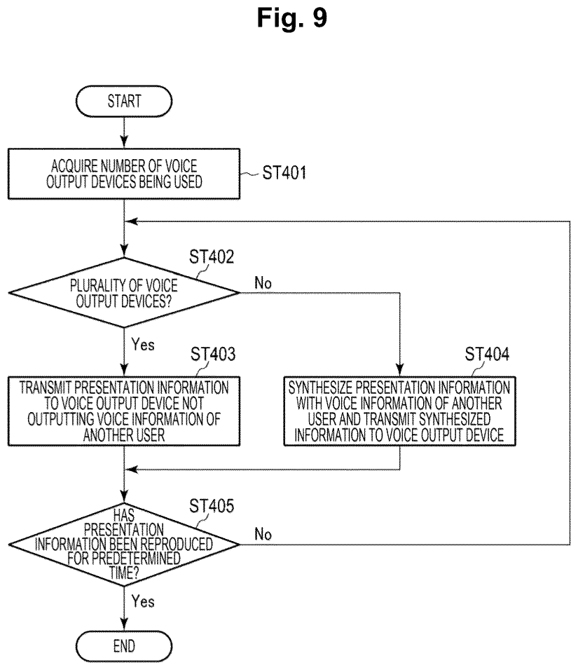

FIG. 9 is a flowchart illustrating an example in which the operation of step ST104 is described in more detail.

The presentation content control unit 103 acquires the number of voice output devices 54 connected with the information presentation device 1 via the input/output interface 50 (step ST401).

The presentation content control unit 103 determines whether the acquired number of voice output devices 54 is plural or not (step ST402). For example, in a case where the user is wearing a sound conduction type ear device and a bone conduction type ear device, this means that the two voice output devices 54 are connected with the information presentation device 1. In such a case, the presentation content control unit 103 determines that the user is wearing a plurality of voice output devices 54. On the other hand, in a case where the user is wearing either a sound transmission type ear device or a bone conduction type ear device, this means that one voice output device 54 is connected with the information presentation device 1. In such a case, the presentation content control unit 103 determines that the user is wearing one voice output device 54.

The presentation content control unit 103 transmits the presentation information to the voice output device 54 that is not outputting voice information of another user (step ST403). For example, the presentation content control unit 103 receives voice information of another user via the communication interface 40 and the network 6. Then, the presentation content control unit 103 transmits the received voice information to one (first voice output device) of the plurality of voice output devices 54, and outputs the presentation information to one (second voice output device) of the plurality of voice output devices 54 that is not transmitting voice information. For example, the presentation content control unit 103 transmits voice information of another user to the sound transmission type ear device, and transmits the presentation information to the bone conduction type ear device. Here, it is a matter of course that the presentation content control unit 103 may transmit the voice information of another user to the bone conduction type ear device and transmit the presentation information to the sound transmission type ear device. Moreover, in a case where the presentation information includes both the pseudo heartbeat sound and the bubble noise, the presentation content control unit 103 may transmit the pseudo heartbeat sound and the bubble noise to different voice output devices.

The presentation content control unit 103 synthesizes the presentation information with the voice information of another user and transmits the synthesized information to the voice output device 54 (step ST404). The presentation content control unit 103 receives voice information of another user via the communication interface 40 and the network 6. Then, the presentation content control unit 103 transmits information obtained by synthesizing the presentation information with the voice information to the voice output device 54 through the input/output interface 50.

The presentation content control unit 103 determines whether the presentation information has been reproduced by the voice output device 54 for a predetermined time or not (step ST405). For example, in a case where the reproduction time of the presentation information is short, the effect of improving the speech speed or the sound pressure of the user is low. Thus, whether the voice output device 54 has reproduced the presentation information for a predetermined time or not is determined. In a case where it is determined that the voice output device 54 has not reproduced the presentation information for the predetermined time, the processing returns to step ST402. On the other hand, in a case where it is determined that the voice output device 54 has reproduced the presentation information for the predetermined time, the processing ends.

### (Operation and Effect)

According to the embodiment, the information presentation device 1 can control the speech speed and the sound pressure of the utterance of the user involuntarily and non-perceptually with respect to the user in an online meeting or the like. As a result, the user can realize an utterance that is easy to be conveyed to the listener.

### First Variation of Embodiment

In a first variation of the embodiment, the information presentation device 1 acquires the heart rate of the user and outputs the presentation information on the basis of the acquired heart rate.

### (Configuration)

The hardware configuration of the information presentation device 1 in the first variation of the embodiment is the same as that in FIG. 1. Here, it is assumed that the input device 51 includes a wearable terminal or the like and can measure the heart rate of the user. Note that it is a matter of course that the input device 51 is not limited to a wearable terminal and may include any device as long as the device can measure the heart rate of the user. Then, the input device 51 outputs the measured heart rate to the information presentation device 1.

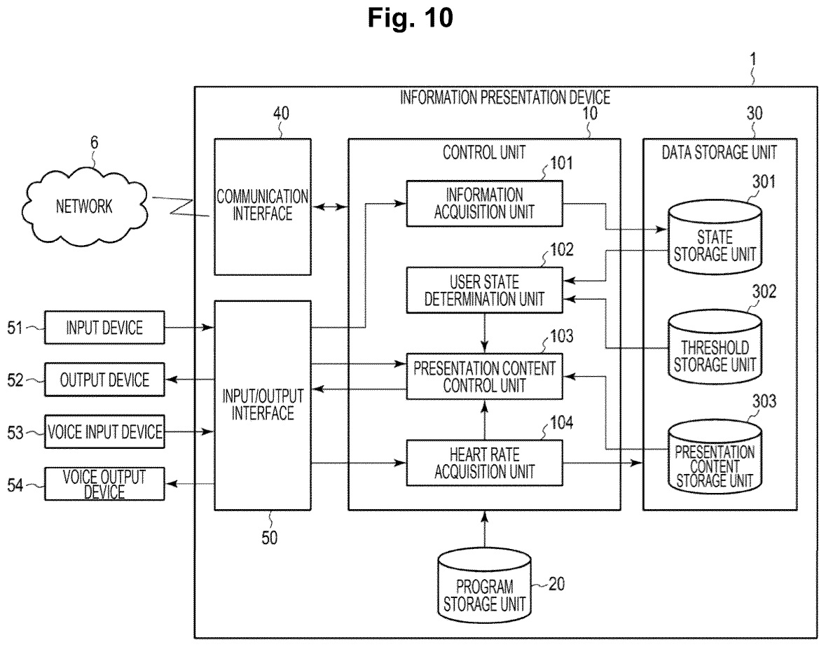

FIG. 10 is a block diagram illustrating a software configuration of the information presentation device 1 according to the first variation of the embodiment in association with the hardware configuration illustrated in FIG. 1.

The difference from the embodiment is that the control unit 10 includes a heart rate acquisition unit 104.

The heart rate acquisition unit 104 receives the heart rate from the input device 51 and outputs the received heart rate to the presentation content control unit 103. Moreover, the heart rate acquisition unit 104 may store the heart rate received from the input device 51 in the data storage unit 30.

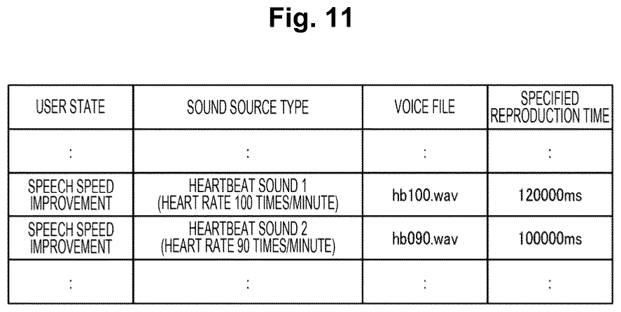

FIG. 11 is a diagram illustrating an example of the presentation information stored in the presentation content storage unit 303.

In the variation of the embodiment, a plurality of pseudo heartbeat sounds are stored in order to present a pseudo heartbeat sound according to the heart rate of the user.

### (Operation)

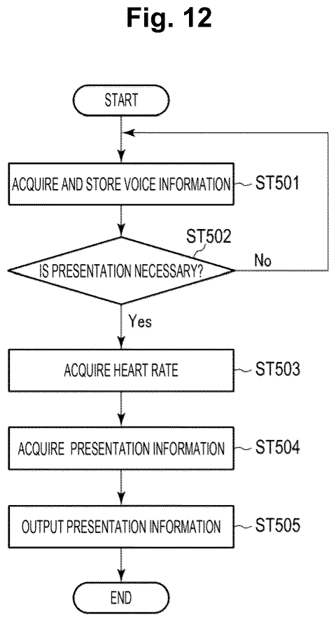

FIG. 12 is a flowchart illustrating an example of an information presentation operation of the information presentation device 1.

The control unit 10 of the information presentation device 1 reads and executes a program stored in the program storage unit 20, thereby implementing the operation of this flowchart.

Since steps ST501 and ST502 in FIG. 12 are the same as steps ST101 and ST102 described with reference to FIG. 3, the description of these steps will be omitted. Here, in step ST502, the user state determination unit 102 outputs a speech speed improvement signal or an improvement signal to the presentation content control unit 103.

The heart rate acquisition unit 104 acquires a heart rate (step ST503). The heart rate acquisition unit 104 receives the heart rate of the user from the input device 51 through the input/output interface 50. The heart rate acquisition unit 104 outputs the acquired heart rate to the presentation content control unit 103.

The presentation content control unit 103 acquires presentation information (step ST504). For example, in a case where the heart rate of the user acquired in step ST503 is 120 times/min, a file that is a pseudo heartbeat sound of 110 times/min may be acquired as the presentation information. For example, the presentation content control unit 103 may acquire a pseudo heartbeat sound that is approximately 10% less than the heart rate of the user as the presentation information.

Since step ST505 is the same as step ST104 described with reference to FIG. 3, the description of this step will be omitted.

Note that the operation described with reference to FIG. 12 can be repeatedly applied. For example, in a case where the heart rate acquired in step ST503 of the first processing is 120 times/min, the presentation content control unit 103 acquires a voice file of a heartbeat sound of 110 times/min. Then, the presentation content control unit 103 outputs the voice file to the voice output device 54 as presentation information. On the other hand, in a case where the heart rate acquired in step ST503 of the second processing has decreased to 110 times/min by the first processing, the presentation content control unit 103 acquires a voice file of a heartbeat sound of 100 times/min. Then, the presentation content control unit 103 outputs the voice file of 100 times/min to the voice output device 54 as presentation information. In this manner, the presentation content control unit 103 can switch the voice file to be aurally presented according to the current heart rate of the user.

### (Operation and Effect)

According to the first variation of the embodiment, the control unit 10 acquires the heart rate of the user, and outputs presentation information to the voice output device 54 according to the acquired heart rate. As a result, it is possible to promote a more effective change in the heart rate as compared with a case where a pseudo heartbeat sound having a heart rate significantly different from the current heart rate is presented to the user as the presentation information.

### Second Variation of Embodiment

In a second variation of the embodiment, the speech speed information or the sound pressure information is acquired while a speaker is reproducing the presentation information, and whether the speech speed information or the sound pressure information has been improved to fall within a reference range or not is determined.

### (Configuration)

Since the configuration of the second variation of the embodiment is the same as the configuration of the embodiment, the description thereof will be omitted here.

### (Operation)

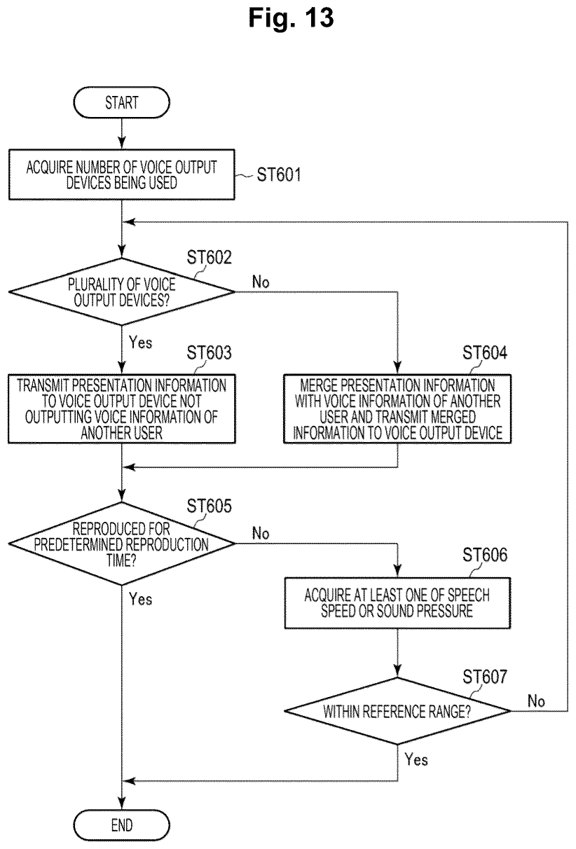

FIG. 13 is a flowchart illustrating an example in which the operation of step ST104 is described in more detail.

Since steps ST601 to ST605 are the same as steps ST401 to ST405 described with reference to FIG. 9, the description of these steps will be omitted.

The presentation content control unit 103 acquires the latest average speech speed or average sound pressure calculated by the user state determination unit 102 (step ST606). For example, in a case where the presentation information is a pseudo heartbeat sound for improving the speech speed, the presentation content control unit 103 may acquire the average speech speed from the user state determination unit 102. Similarly, in a case where the presentation information is a bubble noise for improving the sound pressure, the presentation content control unit 103 may acquire the average sound pressure from the user state determination unit 102.

The presentation content control unit 103 determines whether at least one of the acquired average speech speed or average sound pressure falls within a reference range or not (step ST607). Here, the reference range may be any range, and for example, may be the same value as the speech speed threshold or the sound pressure threshold. For example, in the reference range, the average speech speed may be equal to or less than the speech speed threshold. Alternatively, in the reference range, the average sound pressure may be equal to or more than the sound pressure threshold. In a case where it is determined that the average speech speed or the average sound pressure is not within the reference range, the processing returns to step ST602. On the other hand, in a case where the average speech speed or the average sound pressure is within the reference range, the processing ends.

As described above, the presentation content control unit 103 can output the presentation information until at least one of the speech speed or the sound pressure falls within the reference range.

### (Operation and Effect)

According to the second variation of the embodiment, whether the speech speed or the sound pressure of the user has been improved to fall within the reference range or not is determined while the presentation information is outputted to the voice output device 54. As a result, the information presentation device 1 can detect that the speech speed or the sound pressure of the user has changed to fall within an appropriate range while outputting the presentation information, and can stop outputting the presentation information.

### Other Embodiments

Although the above embodiment has described an example in which the presentation information is outputted to the voice output device 54, the presentation content control unit 103 may output the presentation information to a display that is the output device 52. Here, in a case where the presentation information is a pseudo heartbeat sound, the output device 52 changes and displays the object, the size, the hue, and the like according to the pseudo heartbeat sound. Furthermore, in a case where the output device 52 includes a tactile device, presentation may be performed with intensity of vibration corresponding to the pseudo heartbeat sound. Note that, in a case where the presentation information is a bubble noise, the presentation content control unit 103 may output the presentation information to the voice output device 54. That is, the presentation content control unit 103 may transmit the pseudo heartbeat sound to the output device 52 and transmit the bubble noise to the voice output device. Moreover, the output device 52 may be a display used in an online meeting or the like, or may be a different display.

Note that the presentation content control unit 103 may be configured by combining these embodiments. That is, it is a matter of course that the presentation content control unit 103 may output the presentation information to the output device 52 while outputting the presentation information to the voice output device 54.

Moreover, the methods described in the above embodiments can be stored in a storage medium such as a magnetic disk (Floppy (registered trademark) disk, hard disk, etc.), an optical disk (CD-ROM, DVD, MO, etc.), or a semiconductor memory (ROM, RAM, flash memory, etc.), for example, as programs (software means) that can be executed by a computing machine (computer), or can also be distributed by being transmitted using a communication medium. Note that programs stored on the medium side also include a setting program for configuring, in the computing machine, software means (including not only an execution program but also a table and a data structure) to be executed by a computing machine. A computing machine that implements the present device reads a program stored in the storage medium, may construct software means by the setting program, and executes the above-described processing by the operation being controlled by the software means. Note that the storage medium described in the present specification is not limited to a storage medium for distribution, and includes a storage medium such as a magnetic disk or a semiconductor memory provided inside a computing machine or in a device connected via a network.

In short, the present invention is not limited to the above embodiment, and various modifications can be made in the implementation stage without departing from the gist thereof. Moreover, embodiments may be implemented in appropriate combination if possible, and in this case, combined effects can be obtained. Furthermore, the above embodiment includes inventions at various stages, and various inventions can be extracted by appropriate combinations of a plurality of disclosed components.

### REFERENCE SIGNS LIST

1 Information presentation device
10 Control unit
101 Information acquisition unit
102 User state determination unit
103 Presentation content control unit
104 Heart rate acquisition unit
20 Program storage unit
30 Data storage unit
301 State storage unit
302 Threshold storage unit
303 Presentation content storage unit
40 Communication interface
50 Input/output interface
51 Input device
52 Output device
53 Voice input device
54 Voice output device
6 Network

1. An information presentation device, comprising:
acquisition circuitry configured to acquire a speech speed and a sound pressure of an utterance at a predetermined interval;
determination circuitry configured to determine whether at least one of the speech speed or the sound pressure needs to be improved or not; and
presentation content control circuitry configured to acquire a pseudo heartbeat sound in a case where it is determined that the speech speed needs to be improved, acquire a bubble noise in a case where it is determined that the sound pressure needs to be improved, and output presentation information including at least one of the pseudo heartbeat sound or the bubble noise.

2. The information presentation device according to claim 1, wherein:
the presentation content control circuitry outputs the pseudo heartbeat sound to a first device and outputs the bubble noise to a second device.

3. The information presentation device according to claim 1, further comprising:
a first voice output speaker and a second voice output speaker,
wherein the presentation content control circuitry outputs voice information from a listener of the utterance to the first voice output speaker and outputs the presentation information to the second voice output speaker.

4. The information presentation device according to claim 1, wherein;
the presentation information is information obtained by synthesizing voice information from a listener of the utterance and at least one of the pseudo heartbeat sound or the bubble noise.

5. The information presentation device according to claim 1, further comprising:
acquisition circuitry configured to acquire a heart rate of a user who is giving the utterance,
wherein the presentation content control circuitry acquires the pseudo heartbeat sound on the basis of the heart rate.

6. The information presentation device according to claim 1, wherein;
the presentation content control circuitry outputs the presentation information until at least one of the speech speed or the sound pressure falls within a reference range.

7. An information presentation method, comprising:
acquiring a speech speed and a sound pressure of an utterance at a predetermined interval;
determining whether at least one of the speech speed or the sound pressure needs to be improved or not;
acquiring a pseudo heartbeat sound in a case where it is determined that the speech speed needs to be improved;
acquiring a bubble noise in a case where it is determined that the sound pressure needs to be improved; and
outputting presentation information including at least one of the pseudo heartbeat sound or the bubble noise.

8. A non-transitory computer readable medium storing an information presentation program for causing a processor to perform the method of claim 7.
